(19) United States
(12) Patent Application Publication
(10) Pub. No.: US 2018/0149186 A1
(43) Pub. Date: May 31, 2018

(54) Bolts, Nuts and Fastener System

(71) Applicant: Philip Bogrash, Ashdod (IL)

(72) Inventor: Philip Bogrash, Ashdod (IL)

(21) Appl. No.: 15/634,342

(22) Filed: Jun. 27, 2017

Related U.S. Application Data
(60) Provisional application No. 62/427,451, filed on Nov. 29, 2016.

(51) Int. Cl. F16B 39/22; F16B 39/30; F16B 39/04

(52) U.S. Cl. CPC F16B 39/225; F16B 39/04; F16B 39/30

(57) ABSTRACT

The bolts of this invention have been provided with the various means for preventing torque transmission to the bolt head when the nut is being tightened, thereby eliminating the need to hold it by a wrench while the nut is being tightened. A nut with a helical or similar cut is provided in order to assure more even distribution of stress among its thread coils. A few different flexible bolts are provided for assembling misaligned flanges and other misaligned connections. Lastly fasteners comprising very strong and light synthetic fiber string with a simple hoist-like assembly on one end and a round stopper-head on the other have been provided, not using the thread at all, to replace the heaviest, longest and most expensive bolts and nuts used on large pipes and pressure vessels or in applications where weight reduction is important.

### RELATED APPLICATIONS

The present patent application is related pursuant to the concept of the unity of invention to U.S. provisional patent application 62/427,451 and claims benefit of the filing date on Nov. 29, 2016 of said provisional application.

### 1. FIELD OF THE INVENTION

This invention relates to fasteners and particularly to bolts and nuts as well as non-threaded fasteners intended to replace bolts and nuts.

### 2. DESCRIPTION OF THE PRIOR ART

At the present time there is a variety of known bolts and nuts, but they all have the same serious shortcomings. They require the bolt head to be held by a wrench when the nut is being tightened or untightened. That means a worker needs two wrenches and both of his hands used to tighten or undo a bolted connection and for larger bolt sizes frequently require two persons to tighten or undo a bolted connection. They are very often extremely difficult to assemble when the matching bolt holes on the parts being assembled are not aligned, as usually happens when steel structures or piping networks are being assembled in the field and for example for large pipes it may take a team of workers, using hoists and jacks and/or cranes, several hours or even the whole day to assemble one misaligned flange connection. Furthermore the bolts and nuts for larger sizes holes are very heavy and when a large number of them are used such as for example in pressure vessels or large pipes connected by flanges they add considerable weight to the structure. Thread overtightening routinely leads to thread damage or leveling and that is partly caused by very uneven force/stress distribution acting on thread coils with by far the largest load/stress being held by the first thread coil. Lastly the threaded connections are constantly at risk of coming undone due to vibration causing the need for various types of lock-washers and other securing means which sometimes fail. All of these shortcomings or disadvantages require solutions.

### 3. OBJECTS AND ADVANTAGES

One object of the present invention is to provide a threaded connection that doesn't need that the opposing side of the side being tightened or unscrewed be held by a wrench.

Another object is to make possible to assemble connections where the matching bolt holes are misaligned.

Another object is to provide the components for threaded connections that are of much lower weight.

Another object is to provide the fastening system performing the same functions as the bolted connections and having of the above objects realized while not featuring any threads at all.

Another object is to provide the nut producing much more uniform distribution of stress between thread coils.

Another object is to provide the nut with the self-locking capability.

### 4. BRIEF DESCRIPTION OF THE DRAWINGS

FIG. 1 is the view of bolt of the first embodiment.

FIG. 2 is the cross-sectional view of bolt of first embodiment.

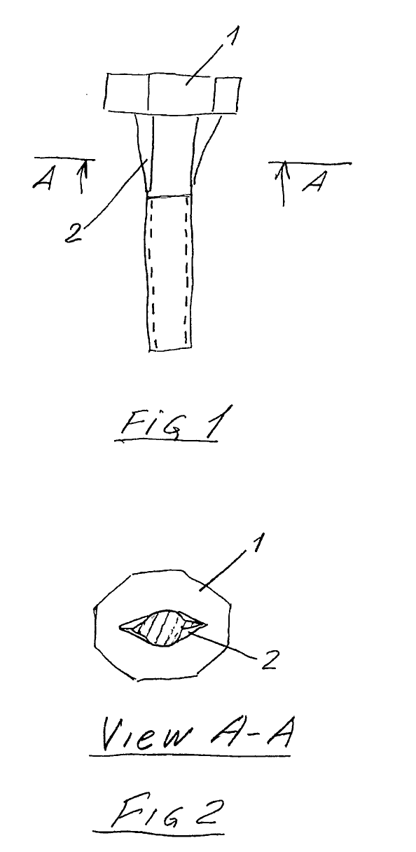

FIG. 1A shows bolt of second embodiment.

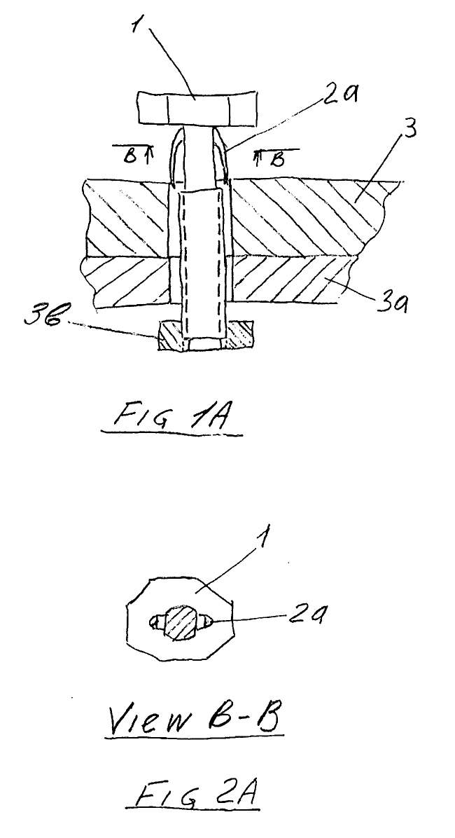

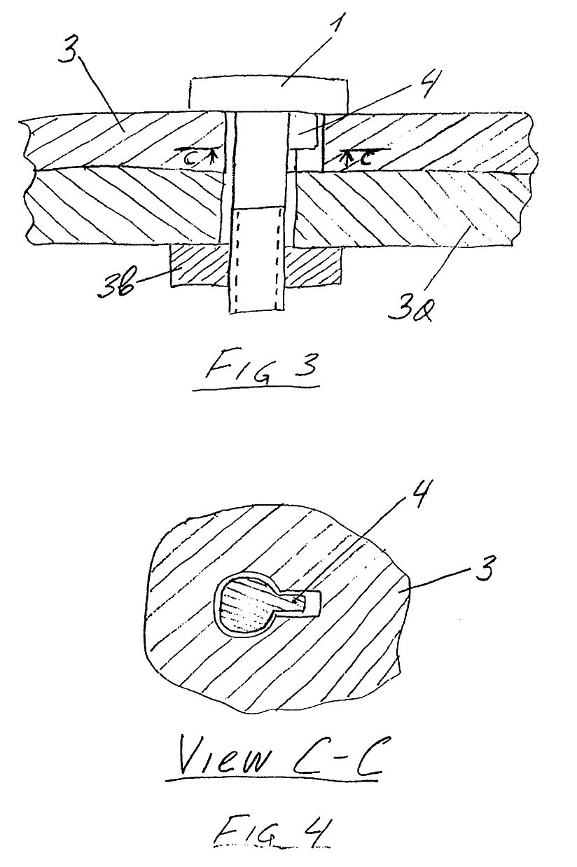

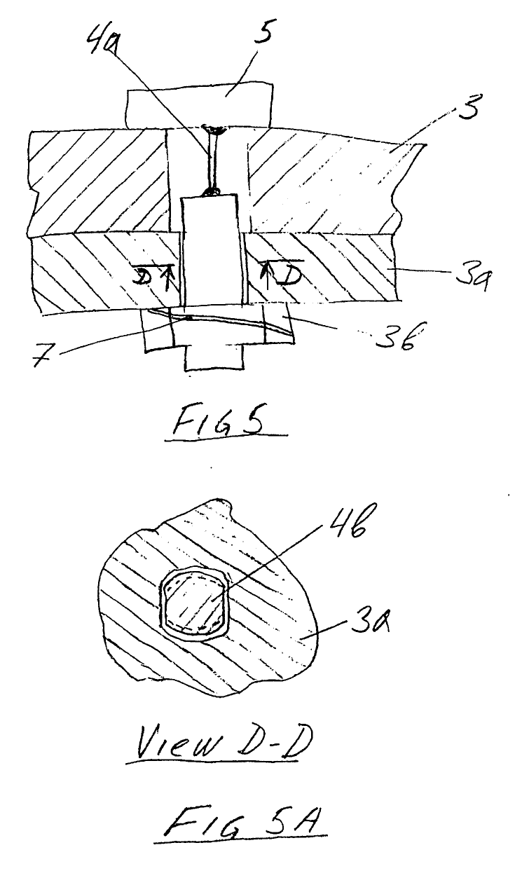

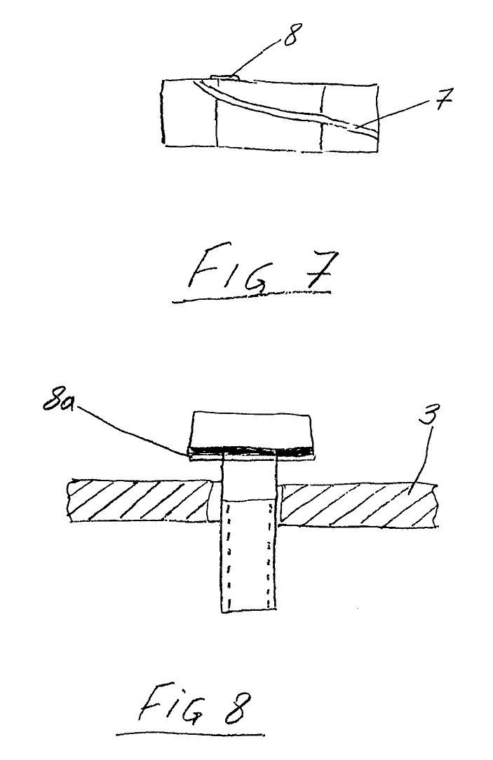

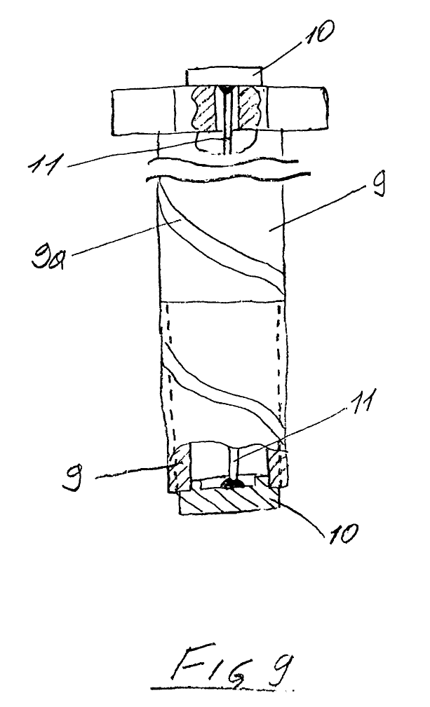

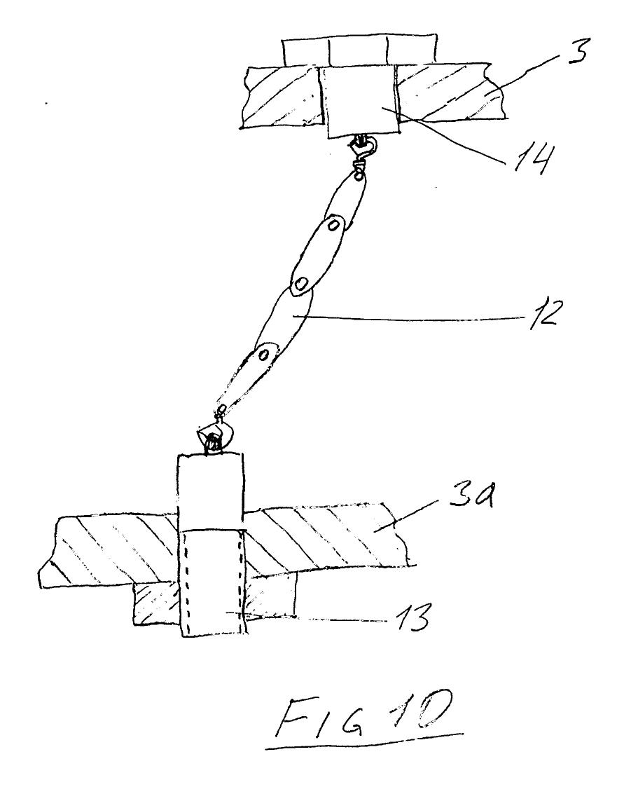

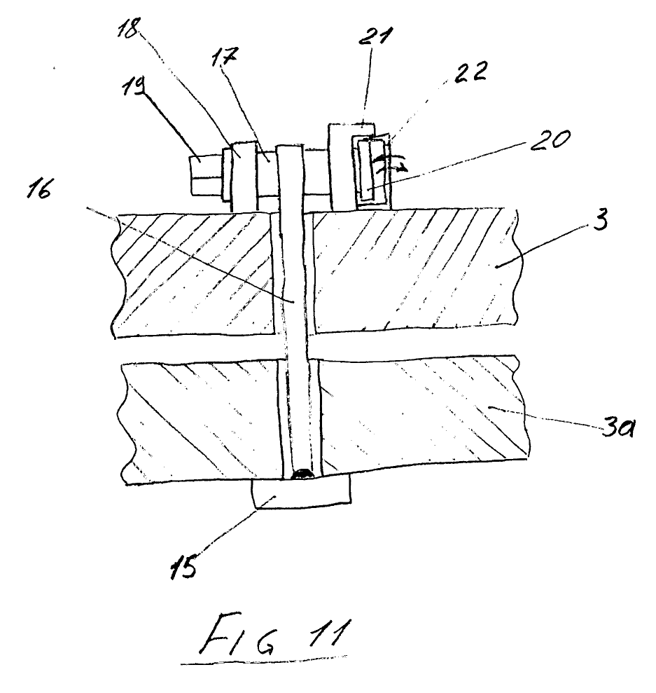

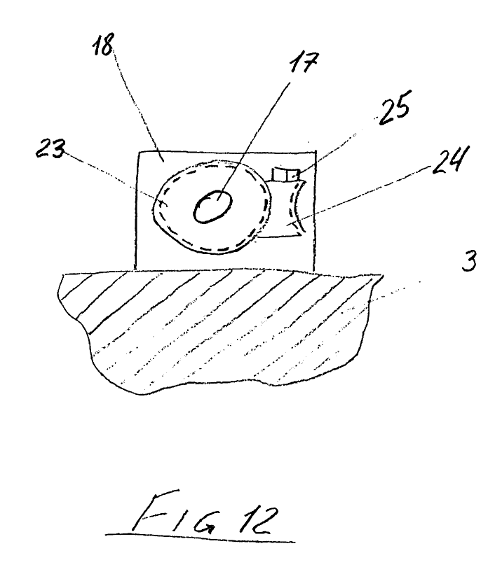

FIG. 2A shows a cross-sectional view of bolt of second embodiment.

FIG. 3 shows bolt of third embodiment.

FIG. 4 shows cross-section of bolt of third embodiment.

FIG. 5 shows in assembly bolt and cut nut of fourth embodiment.

FIG. 5A shows a cross-section of bolt of fifth embodiment.

FIG. 7 shows a spring like cut nut of fifth embodiment.

FIG. 8 is the view of bolt of the fifth embodiment.

FIG. 9 shows the bolt of sixth embodiment.

FIG. 10 shows the bolt of seventh embodiment.

FIG. 11 shows a fastener of the eighth embodiment in an assembly.

FIG. 12 shows a version of eighth embodiment with worm gear on shaft.

### 5. DESCRIPTION

The first embodiment of this invention (FIGS. 1 and 2) consists of a bolt under whose head (1) the unthreaded part of said bolt's shank has at least 1, but preferably 2 or more, sharp rib(s) (2) tapered downward. Said ribs' edges are at a distance from the bolt's axis and of hardness sufficient to assure that they very slightly cut into the edges of bolt hole in part (3) which is being held by that threaded connection. Since the torque is not expected to be transmitted to the bolt head, optionally it can be made more cheaply; smaller and optionally of round shape, but strong enough to withstand the axial force in the threaded connection. It should be noted that the smaller bolts of this embodiment can be easily produced by stamping just like many of known bolts of comparable smaller sizes are.

The second embodiment of bolts of this invention (FIGS. 1A and 2A) consist of a bolt under whose head there are two or more offshoots or branches (2a) stemming from its shank which are elastically flexible the more the further they are from their base. Said offshoots' tips are within a predetermined distance from the shank's central axis to assure that they will enter the round hole in part (3) at the assembly time with said hole being of a predetermined diameter for a specific bolt size. The other part being joined is (3a) and nut (3b). The offshoots are curved so as to produce their elastic bending and therefore pressure onto the sides of hole (3) when the bolt, and thus its offshoots, is pressed or tapped to enter the hole (3) and thus also produce a substantial and predetermined force of static friction to prevent the bolt from turning once the tightening starts. It should be noted that the smaller bolts of this embodiment can be easily produced by stamping just like many of known bolts of comparable smaller sizes are. The features of the first and second embodiments can be combined, so that the offshoots (2a) stemming from the shank are elastically flexible along most of their length, but are rigid and have sharp edges like rib edges (2) in the first embodiment in the immediate vicinity of their attachment to the shank.

The third embodiment (FIGS. 3 and 4) features at least one lug or knob or corner (4) on the bolt which enters into a matching profile of a hole in part (3) being assembled in order to prevent torque transmission to the bolt's head and thus to eliminate the need to hold the bolt's head while tightening or unscrewing the threaded connection. Said lug(s) can optionally be made thin enough to have a predetermined degree of flexibility in order to absorb, if it were to happen due to thermal expansion of the part (3), a very small creep of part (3). Since the tightening torque is not transmitted to the bolt head it can be made more cheaply; round and smaller, but strong enough to withstand the axial force in the threaded connection. As today holes for the fasteners are commonly cut by laser cutters, plasma cutters or various punching machines, suitable non-circular hole shapes can be produced just as easily and at the same cost as the circular ones. The same is true for the holes in cast or stamped parts. In cases where holes are drilled, two overlapping holes with the same or different diameters can be made one after another resulting in one co-joined hole of non-circular shape suitable for these bolts. It should be noted that the smaller bolts of this embodiment can be easily produced by stamping just like many of known bolts of comparable smaller sizes are. Alternatively the bolt's pertinent cross-section can be made of other non-circular shapes such as oval, rectangle etc with the hole on a part (3) being of a corresponding shape to that of said bolt's cross-section. Clearly there can be a great variety of said non-circular shapes and mutatis mutandis they are all considered to be within the scope and spirit of this invention.

In the fourth embodiment (FIG. 5 and FIG. 5a) the non-circular hole is located in the other part being assembled (3a) which is facing the nut (3b). As the torque therefore is not transmitted to the length of the bolt, it only bears the axial tensile load and therefore it consists of a metal shank of predetermined smaller diameter compared to known bolts for the same axial load. Optionally instead of a metal shank it comprises a string or strut made of materials vastly stronger and lighter than steel, such as graphene or carbon fiber or Kevlar®. Said string (4a) will preferably comprise a small diameter metal wire to render said string (4a) stiffer and bendable for easier use and can be tied or otherwise attached by known means to the threaded rod (4b) and to the bolt head (5) which is also made round and of a pre-determined smaller size. Said bolt-head needs to be strong enough to withstand the axial load. Bolt head (5) and/or threaded rod (4b) can optionally be made to be hooked or otherwise attached by known means to string (4a) at the threaded connection's assembly time or they would come pre-assembled. The threaded rod (4b) has at least one segment on its side cut off (6), which clearly decreases the strength of each thread coil. To mitigate that by means of more evenly distributing the stress between thread coils, a nut (FIG. 6) is cut like a cut spring. Such cutting can be implemented for example by a lathe and it is complete with a see-through cut (7) thereby turning the nut into a variety of a very short cut spring. In first version the thread in the nut has pitch which is larger by a predetermined very small amount compared to the thread of the bolt which will cause the helically cut nut to be compressed while being forced onto slightly lower thread pitch bolt. Nut compression will produce a force acting to counteract the very large force from the bolt's thread coil pressing forward on the nut's first thread coils immediately adjacent to the nut's face pressing forward against the part, that's being assembled, surface. At the same time the rear thread coils of the nut will be pressing on the bolt's thread coils rearward, thus distributing the force acting on the nut's thread along its length; which is our objective. That kind of nut likely won't need lock-washers. Alternatively in a second version, the nut's thread pitch will be the same as that of the bolt, the helical cut's direction is counterclockwise with a large predetermined pitch size, the cut is of predetermined width and the holes through helically cut nut's coils are at locations which line up when the tightening is completed and the nut is twisted into position wherein the helical cut almost or practically “closes”. At that point a pin is inserted through the now aligned holes and the nut stays twisted and compressed because of the pin preventing its untwisting upon tightening wrench removal. Alternatively such nut's untwisting can be prevented by placing on it a retainer bracket shaped as a round or hexagonal bracket. Said retainer bracket may be placed on the nut's narrower collar (not shown). Nut's compression will produce the distribution of stress on coil threads as described above. Third version of the helically cut nut (FIG. 7) features a bulge (8) which serves to put pressure onto the next spring-like coil located across the cut from the beginning of the first coil which is located just in front of the leading end of the nut's thread. Optionally in this version a narrow central core of nut material (such as steel) of predetermined diameter is still left in place along the length of said cylindrical spiral (helical) cut, so that the cut is not complete, to make the body of said nut to act more like an integral whole while still providing a possibility of very small relative movement between the coils formed by this cut, compared to known solid nuts and therefore better stress distribution between the thread coils. As these nuts can be expected to have a higher load bearing capacity compared to prior art nuts, they likely can be made of lower height, with fewer thread coils. Naturally such helically cut nuts can also be used with all the other embodiments of this invention featuring the threaded bolts as well as prior art bolts.

Fifth embodiment of this invention (FIG. 8) is primarily intended for use on the existing machinery and structures where there are no non-circular bolt holes and where the use of ribbed bolts of first embodiment is not possible due to unacceptability of making indentations in the bolt hole perimeter or impossibility of tapping bolt into place due to lack of room for that, fragility of the part being connected etc. The bolt will have on its head's underside surface facing the part (3) a layer of rapid acting glue covered and sealed by a removable plastic film (8a). The glue of known variety will preferably be strong yet fragile so that when the bolt, when it needs to be removed, can be easily loosened by tapping on its end once the nut has been unscrewed. The sixth embodiment of this invention (FIG. 9) features flexible bolts suitable for assembling moderately misaligned flanges and connections. Said bolts feature the shank, fully or partially threaded along its length, made of relatively thick-walled tubing (9) along the length of which runs a helical cut (9a), similar to what was described for the nuts of fourth embodiment, with a much larger pitch compared to the pitch of the thread. That cut is intended to make the shank flexible, however the flexibility of such bolts will be inversely proportional to said cut's pitch dimension. Said cut also weakens the shank potentially making it susceptible to irreversible plastic tensile deformation along its length in cases of relatively small cut pitch. To eliminate the possibility of this kind of axial deformation, optionally the stoppers (10) at both ends of the bolt are held by a suitable string (11) made of materials of sufficient strength similarly to what was described for the string (FIG. 5, item 4a) and its hook ups and/or attachments in the fourth embodiment. A helical cut nut as described in the fourth embodiment would be preferable to use with this bolt. Clearly the bolt of this embodiment can be implemented in conjunction with the features of other embodiments such as the first, second or third embodiment or of conventional prior art bolts, requiring the bolt head to be held by a wrench while the nut is tightened. As this bolt will be relatively more expensive it is likely to be used only for the assembly process to be replaced with a cheaper bolt of other embodiments or a conventional prior art bolt once the flanges or connections have been aligned and other bolts are in place holding them together.

The seventh embodiment of this invention is a highly flexible bolt (FIG. 10) for aligning and pulling together the significantly misaligned flanges and other connections. It will comprise a flexible chain (12) similar to chains used in chain drives which can easily flex within their plane, but cannot be twisted and will transmit the tightening torque to the bolt head if it is implemented as in a conventional prior art bolt. The chain will be welded, hooked or attached by other suitable known means to the threaded rod (13), onto which the nut is placed, and to the bolt's very short shank (14) or optionally, if appropriate, to the bolt head directly. Alternatively instead of a chain a suitable flexible shaft can be used which will also transmit torque to the bolt's head. Furthermore the bolts of this embodiment can also be implemented with the features of other embodiments such as of the first, second or third embodiment assuring that the bolt head stays in place and does not turn during bolt tightening. When the chain (12) is hooked or otherwise attached by easily removable means to the short shank (14) and threaded rod (13) the length of all 3 components can be selected as needed in each particular case.

The eighth embodiment is a threadless fastener system intended to replace the threaded bolts and nuts (FIGS. 11 and 12) and is particularly well suited to replace the large, expensive bolts and nuts, typically with low-friction coating, whose weight is often much more than one kilogram, used for example for connecting by flanges large diameter pipes with various valves in pipelines as well as in industrial piping networks and in pressure vessels. It is also suitable for use in a variety of other threaded connection applications where it is advantageous to reduce said threaded connections weight; such as for example in aviation. It will comprise a round stopper-head (15) with a function analogous to that of a bolt head with a flexible strip or string (16) attached to it by known means similarly to what was described for string (4a) in fourth embodiment. Said strip (16) may be flat and its other end will be inserted through the elongated opening of the shaft (17) and wound onto it. Alternatively said string (16) may be round and wound onto shaft (17) which in that case will have helical groove (not shown) on its otherwise cylindrical surface for the string coils. Shaft (17) is mounted on support structure of hoist (18) and has on one side either a square or hexagon end (19) while on the other side it has a disc with a spiral coil outline (20) and above it a lip (21) which is a part of support (18). On said support (18) below said disc (20) is mounted a bendable strip (22) with a wedge shaped tip in front of the gap between said disc (20) and lip (21). Alternatively instead of disc (20) for preventing the unintended unrolling of said strip or string (16) a sprocket can be used, with said sprocket being coupled with a ratchet instead of a strip with a wedge (22).

Said stopper-head and the hoist assembly can be made of suitable light weight materials such as for example carbon fiber for applications where weight reduction is important. In the second version of this embodiment (FIG. 12) a worm gear (23) is mounted on shaft (17) instead of the faceted ending (19) in mesh with a worm shaft (24) mounted onto support structure (18) either horizontally or vertically. Said worm shaft (24) will have a faceted ending (25), either square or hexagonal for the wrench. There are other possible designs of the hoist mechanism with a lock and mutatis mutandis they are all considered to be within the scope and spirit of this invention.

### 6. SKETCHES AND DIAGRAMS

Sketches provided separately

### 7. OPERATION

For the first embodiment the sharp edges of ribs (2) due to the wedging effect will initially cut into the edges of bolt hole in part (3) when the bolt head is tapped in the beginning of tightening. As the tightening progresses said edges (2) will cut more deeply into the hole's edges and thus will stay in place as the tightening torque increases.

The operation of bolts of the second embodiment is adequately described in the Description Section and their description of operation will not be re-iterated here, but is included by way of reference as if fully set forth.

The operation of bolts of the third embodiment is adequately described in the Description Section and their description of operation will not be re-iterated here, but is included by way of reference as if fully set forth.

The operation of bolts and nuts of the fourth embodiment is adequately described in the Description Section and their description of operation will not be re-iterated here, but is included by way of reference as if fully set forth.

The operation of bolts of the fifth embodiment is adequately described in the Description Section and their description of operation will not be re-iterated here, but is included by way of reference as if fully set forth.

The operation of bolts of the sixth embodiment is adequately described in the Description Section and their description of operation will not be re-iterated here, but is included by way of reference as if fully set forth.

The operation of bolts of the seventh embodiment is adequately described in the Description Section and their description of operation will not be re-iterated here, but is included by way of reference as if fully set forth.

For the fastener of eighth embodiment; support structure of the hoist (18) will be placed over the hole in part being assembled, whereas the stopper-head (15) with attached flexible strip (16) are mounted by means of putting said strip through the holes in the flanges being assembled and then through the elongated opening of shaft (17) and wound onto it. On hexagon end (19) of said shaft 17 will be placed a wrench socket, with said wrench usually being hydraulic or pneumatic, also it can be manual. When the desired degree of tightening is achieved, the bendable strip with a wedge tip (22) is pushed forward into the narrow gap between the spiral outline disk (20) and lip (21) and is wedged in said narrow gap thereby fixing the exact position of disc (20) and thus also the shaft (17) preventing any slackening of the strip (16). To undo the connection the wedge of bendable strip (22) is pulled back releasing the disc (20) and the shaft (17) onto which said disc is mounted, allowing either wrench controlled unwinding of strip (16) from the shaft (17) or, if circumstances permit, unwinding it at once by pulling on stopper-head (15). If an optional version of this embodiment (FIG. 12) is used which has built in worm gear for torque magnification, then the wrench socket will be put onto faceted ending (25) of worm shaft. This fastening system will permit the assembly, by using a small plurality of such fasteners intermittently tightened one after another, of a moderately misaligned flange.

What claimed is:

1. A bolt with stopping feature which is meant to come into contact with the work part, selected from the group consisting of:
tapered ridges and
elastic offshoots and
non-circular cross-section matching cross-section of a hole and
glue covered surface
whereby said bolt is prevented from turning and its head does not have to be held during nut tightening.

2. A fastener system comprising a flexible bolt and a flexible nut.

3. The bolt of claim 2 provided with flexibility by having a feature selected from the group consisting of:
shank with helical cut and
flexible component.

4. The nut of claim 2 having a helical cut from top to bottom and provided with a locking feature selected from a group consisting of:
predetermined small difference in thread pitch of bolt and nut and
holes in nut coils and pin insertable therethrough upon tightening completion and
retainer bracket.

5. The bolt of claim 3 wherein said shank has central hole along its axis and a non-extendable flexible element passed through it and attached to both ends of the bolt to prevent its lengthening.

6. The bolt of claim 3 wherein said flexible element is a flexible in one plane chain, suitable for torque transmission and operatively connected to a threaded rod on one end and is operatively connected to a bolt head on the other end.

7. The bolt of claim 3 wherein said flexible element is a flexible shaft suitable for torque transmission and operatively connected to a threaded rod on one end and is operatively connected to a bolt head on the other end.

8. The bolt of claim 3 wherein said flexible element is a string operatively connected to a threaded rod with non-circular cross-section which is put through a hole of matching non-circular shape in a work part on one end and is operatively connected to a bolt head on the other end.

9. A fastener system comprising string which is operatively connected to a hoist on one end and is operatively connected to a bolt head on the other end.

10. The fastener system of claim 9 wherein said hoist comprises a turnable cylindrical member onto which said string is reeled and includes a lock for prevention of unintended string unreeling.

11. The fastener system of claim 10 wherein said lock is a ratchet mechanism mounted on cylindrical member.

12. The fastener system of claim 10 wherein said lock is a wedging mechanism comprising a non-circular disk mounted on cylindrical member, non-moving part of structure at a predetermined small distance from the edge of said disk and a moveable wedge.

13. The fastener system of claim 10 further comprising a worm gear mechanism which includes worm gear mounted on the cylindrical member and worm shaft for magnifying the torque applied to said cylindrical member.
